(19) United States
(12) Patent Application Publication
(10) Pub. No.: US 2010/0310672 A1
(43) Pub. Date: Dec. 9, 2010

(54) DISINFECTANT BASED ON AQUEOUS; HYPOCHLOROUS ACID (HOCI)-CONTAINING SOLUTIONS; METHOD FOR THE PRODUCTION THEREOF AND USE THEREOF

(76) Inventors: Alfons Beltrup, Hungen (DE); Lars Füchtjohann, Nachrodt-Wiblingwerde (DE); Steven Gross, Beerfelden (DE); Bernd Jöst, Abststeinach (DE)

Correspondence Address: PATENTANWAELTE LICHTI + PARTNER GBR, POSTFACH 41 07 60, D-76207, KARLSRUHE, DE

(21) Appl. No.: 12/599,509

(22) PCT Filed: May 14, 2008
(86) PCT No.: PCT/EP08/03863

§ 371 Date: Aug. 11, 2010

(30) Foreign Application Priority Data
May 15, 2007 (EP) 10 2007 022 994.3

(51) Int. Cl. A01N 59/00; A01P 1/00

(52) U.S. Cl. 424/600

(57) ABSTRACT

Disclosed are a disinfectant based on an aqueous, hypochlorous acid-containing solution, especially in the form of an electrochemically activated, diluted water/electrolyte solution, as well as a method for producing such a disinfectant. In order to increase the stability of such a disinfectant also in case the disinfectant has a large surface, e.g. when the disinfectant is applied to surfaces, the disinfectant further contains a certain percentage of amorphous silica (SiO₂), particularly in the form of amorphous silicic acids and/or amorphous silicic anhydrides. Said percentage can be selected especially in such a way as to increase the viscosity of the aqueous solution to the point where the solution gels. The invention further relates to the use of such a disinfectant.

The invention relates to a disinfectant based on an aqueous, hypochlorous acid (HOCl)-containing solution, a method for the production thereof, and use thereof.

Disinfectants based on hypochlorous acid are known, hypochlorous acid being an extremely effective substance in respect of its disinfectant properties and providing considerably better disinfectant action, in particular, than its salts, the hypochlorites (OCl⁻), which themselves have disinfectant properties. For the manufacture of disinfectants based on hypochlorous acid/hypochlorite, in addition to other modes of preparation, the method of electrochemical activation is known, which is principally used for the disinfection of water. Herein, a diluted solution of an electrolyte, in particular of a neutral salt such as sodium chloride (NaCl) or common salt, potassium chloride (KCl) or similar, is converted, in an electrolysis reactor by applying a voltage to its electrodes, to an active state, which is suitable for disinfection and which is usually in a metastable state and which, depending on the type of water and the defined process parameters, can be maintained for a prolonged period. Such a method of electrochemical activation (ECA) is described, for example, in the international patent application PCT/EP2007/001265 not yet published by the date of priority of this current application, which as a consequence is hereby incorporated by reference. The electrolysis reactor used in this method features a cathode compartment with one or more cathodes and an anode compartment with one or more anodes, the anode compartment and the cathode compartment being separated from one another by a diaphragm that is electrically conductive—in particular for ions—or by means of a membrane with the said properties, so as to prevent the water/electrolyte solutions from mixing in the two compartments.

In electrolysis, such as chlorine-alkali electrolysis, more or less complete conversion of the reagents used is attempted using a highly concentrated electrolyte solution, becoming chlorine gas (Cl₂) and sodium hydroxide solution (NaOH) in the case of the use of sodium chloride solution, and becoming chlorine gas and potassium hydroxide solution (KOH) in the case of the use of a potassium chloride solution, principally so as to maximize the chlorine gas yield. In electrochemical activation, by contrast, the water/electrolyte solution used is introduced to the electrolytic reactor in a much more diluted form, usually in a concentration of approximately maximum 20 g/l, preferably approximately maximum 10 g/l, in particular, between 0.1 g/l and 10 g/l or between 0.1 g/l and 5 g/l or only between 0.1 g/l and 5 g/l, and only a very small proportion thereof is converted so as to modify the physical and chemical properties of the solution in an advantageous way and, in particular, to increase the redox potential of the water mixed with the electrolyte, by means of which a disinfecting action is obtained. The reaction conditions, such as pressure, temperature, electrode current, etc., selected for the electrochemical activation are generally correspondingly more moderate than for chlorine-alkali electrolysis, which is usually performed at higher temperatures in the range 50° C. to 90° C., whereas electrochemical activation can be performed at room temperature. An advantage of electrochemical activation is, in particular, the good health and environmental compatibility of the substances produced by electrochemical activation in their various concentrations, which are approved and effective as a disinfectant according to the German Drinking Water Ordinance (TrinkwV).

As in electrolysis, in electrochemical activation, too, oxidation is performed at the anode (i.e. at the positively charged electrode), whereas reduction takes place at the cathode (i.e. at the negatively charged electrode). If a diluted neutral salt solution is used, such as a sodium chloride solution, mainly hydrogen will be produced at the cathode according to the reaction equation below (1):

2H₂O+2e⁻→H₂+2OH⁻ (1),

which, after being released from the solution as gas, is removed, for example, from the cathode compartment of the reactor. Moreover, the diluted water/electrolyte solution in the cathode compartment of the electrolysis reactor becomes alkaline due to the formation of hydroxide ions.

In accordance with the following reaction equations (2) and (3), the chemical oxidizing agents oxygen (O₂) and chlorine (Cl₂), in particular, are produced, both of which are known to be effective water disinfectants. Furthermore, it must be noted that the diluted water/electrolyte solution in the anode compartment of the electrolysis reactor becomes acidic due to the formation of H₃O⁺ ions:

6H₂O→O₂+4H₃O⁺+4e⁻ (2),

2Cl⁻→Cl₂+2e⁻ (3)

Chlorine, on the other hand, dissociates in water according to the following balanced reaction (4) into hypochlorite ions (OCl⁻) and chloride ions (Cl⁻), which themselves can react with a suitable cation, e.g. Na⁺, from the electrolyte or with a proton or with an H₃O⁺ ion to form the corresponding (sodium) salt or the corresponding acid, i.e. hypochlorous acid (HClO) or, after recombination with the cations present in the water/electrolyte solution, they can form hypochlorites and hydrogen chloride or diluted hydrochloric acid (HCl):

Cl₂+3H₂O<===>2H₃O⁺+OCl⁻+Cl⁻ (4).

If the pH value and the redox potential are suitably controlled, as is explained in detail in PCT/EP2007/001265 mentioned above, the equilibrium can be shifted toward the most desirable component, that is, hypochlorous acid, resulting in a disinfectant that is extremely effective in very small concentrations. Moreover, small quantities of further substances that are also known to be effective in the disinfection of water can be produced from the said substances formed at the anode by secondary reactions. These are, in particular, hydrogen peroxide (H₂O₂, reaction equation (5)), ozone (O₃, reaction equation (6)), chlorine dioxide (ClO₂, reaction equation (7)), chlorates (ClO₃⁻, reaction equation (8)), and various radicals (reaction equations (9) and (10)).

4H₂O→H₂O₂+2H₃O⁺+2e⁻ (5),

O₂+3H₂O→O₃+2H₃O⁺+2e⁻ (6),

Cl⁻+4OH⁻→ClO₂+2H₂O+5e⁻ (7),

3OCl⁻→ClO₃⁻+2Cl⁻ (8),

5H₂O→HO₂.+3H₃O⁺+3e⁻ (9),

H₂O₂+H₂O→HO₂.+H₃O⁺+e⁻ (10)

One disadvantage of disinfectants produced by means of electrochemical activation is that they usually have only limited stability or storage life. As indicated above, the stability of the disinfectant can be increased to a duration of approximately half a year to a year by suitable open-loop or closed-loop control, in particular, as disclosed by the said international patent application PCT/EP2007/001265, but in this case the disinfectant should be kept in a closed container and suitably cooled. Especially in the case of a relatively large surface of contact of the disinfectant with the ambient air, relatively quick neutralization of the disinfectant is practically impossible to prevent. The reason for this is that, according to the above reaction equation (4), an equilibrium prevails between the dissolved chlorine (Cl₂) and the hypochlorous acid (HOCl) and its salts, with the chlorine being released from the solution as gas, which continuously reduces the proportion of chlorine and, in particular, of the hypochlorous acid and its salts, the hypochlorites, which are both active as a disinfectant, because the equilibrium shifts toward the OCl⁻ ions, which react to produce chlorine gas, which, in turn, escapes from the solution. Moreover, hypochlorous acid tends, in particular, as the pH value increases, to cleave off its proton, forming the corresponding hypochlorite, which, as stated above, is less effective as a disinfectant than undissociated hypochlorous acid.

The object of the invention is therefore to form a disinfectant based on an aqueous, hypochlorous acid (HOCl)-containing solution in such a way that its life is increased, in particular, also in the case of a relatively large contact surface thereof with the ambient medium. Further objects are a method for the production thereof and the use thereof.

According to the invention, this object is achieved with a disinfectant of the type stated in the introduction that contains a proportion of amorphous silica (SiO₂).

With regard to process technology, the invention also includes the addition of amorphous silica (SiO₂) to the solution to solve this problem in a method for the production of such a disinfectant based on an aqueous, hypochlorous acid (HOCl)-containing solution.

Surprisingly, it was discovered that the stability of the disinfectant, or, in particular, the life of the hypochlorous acid (HOCl) desired to perform disinfection, can be considerably lengthened by the addition of amorphous silica. It is assumed that amorphous silica inhibits the balanced reaction according to the reaction equation (4) above or fixes the hypochlorite ions, either in the form of hypochlorous acid or in the form of hypochlorites, so that the hypochlorite ions remain in the solution, where they can perform their disinfecting function. In particular, it was surprisingly ascertained that amorphous silica is able to inhibit the cleavage of the proton from hypochlorous acid so that the latter is not dissociated into hypochlorite ions having a less disinfectant action. This is surprising because non-amorphous, i.e. crystalline, silica is known to act as an ion exchanger and favors the cleavage of the proton from hypochlorous acid to become a hypochlorite ion (OCl⁻) that then recombines with a suitable cation to form the corresponding salt. Moreover, a slight odor of chlorine, which may occur otherwise and is not desired in most applications, is also avoided because the chlorine gas dissolved in the disinfectant remains dissolved (in equilibrium with hypochlorous acid or also with the hypochlorite ions) and is not constantly released as chlorine gas due to reaction of the hypochlorite ions or, above all, of the hypochlorous acid. A further advantage of the inventive disinfectant is that silica in the amorphous form is able to attach itself to residue of (killed) bacteria, viruses or other microbes, which can be removed without any problem after disinfection treatment on removal of the disinfectant, e.g. by rinsing.

The amorphous, i.e. non-crystalline, silica can, for example, be used in the form of amorphous silicic acids and/or amorphous silicic anhydrides. For the purpose of the invention, “amorphous silicic acids” refer both to amorphous polysilicic acids with the general formula [—Si(OH)₂—O—] and amorphous orthosilicic (Si(OH)₄) and metasilicic acids ([—SiO—O—]) and all mixed forms thereof. The “amorphous silicic anhydrides” comprise both amorphous silica gels and amorphous precipitated silicic acids (SiO₂), as can be obtained, for example, by a reaction of sodium silicate (Na₂SiO₃) with sulfuric acid producing sodium sulfate, and amorphous pyrogenic silicic acids, as can be obtained, for example, by a reaction of silicon tetrachloride (SiCl₄) with water, producing hydrogen chloride, and are usually present in the form of a fine powder. Moreover, siliceous earth in amorphous form comprising at least 90% SiO₂ by mass can be used directly.

A preferred embodiment of the inventive disinfectant contains a sufficient proportion of amorphous silica to increase the viscosity of the aqueous, hypochlorous acid-containing solution, wherein the disinfectant may, in particular, exhibit a more or less gel-like consistency. Such a disinfectant is therefore produced in such a way that the amorphous silica is added to the aqueous, hypochlorous acid-containing solution in a sufficient proportion to increase its viscosity, wherein, in particular, a sufficient proportion of amorphous silica can be added to cause the solution to gel. In any case, the amorphous silica is advantageously dispersed into the aqueous, hypochlorous acid-containing solution as homogeneously as possible, which can be achieved with practically any suitable agitators, homogenizers, etc.

Such a disinfectant also has the advantage of extremely simple application, for example, for the disinfection of inclined surfaces or also of human or animal skin because the disinfectant is not removed from the intended site of action by gravity but is immobilized there, retaining its excellent disinfecting properties, which are also very skin-compatible. This increases both the duration of the effect and the stability of the disinfectant at the site of action.

The mass ratio of the aqueous, hypochlorous acid-containing solution to the amorphous silica can advantageously be between approximately 100:1 and approximately 1:1, in particular, between approximately 50:1 and approximately 2:1, and will, of course, depend on the desired viscosity of the product. The amorphous silica is added to the aqueous, hypochlorous acid-containing solution in the desired mass ratio and, as already mentioned, is distributed there as homogeneously as possible.

Although the disinfectant based on the aqueous, hypochlorous acid-containing solution can be obtained in any way, a preferred embodiment of the inventive disinfectant is constituted by an electrochemically activated, diluted water/electrolyte solution, that is, the aqueous, hypochlorous acid-containing solution is produced by electrochemical activation (ECA) of a diluted water/electrolyte solution. This can, in particular, be achieved by the electrochemical treatment of water, e.g. tap water or also demineralized water, according to the method described in the international patent application PCT/EP2007/001265 cited above.

In a further advantageous embodiment, the disinfectant, in particular, in this context, contains an exclusively electrochemically activated, anodic, diluted water/electrolyte solution, that is, only the electrochemically activated, diluted water/electrolyte solution obtained at the positive electrode (anode) is used to produce the disinfectant by dispersing the amorphous silica therein.

The production of an anodic solution can also be performed, as explained in PCT/EP2007/001265 cited above, in such a way that the electrochemically activated, diluted water/electrolyte solution is obtained by adding to water an electrolytic solution, in particular, a sodium and/or potassium chloride solution and applying electric current to the water with added electrolytic solution in the form of a diluted water/electrolyte solution in an electrolysis reactor having at least one cathode compartment with a cathode and having at least one anode compartment with an anode that is physically separated from the cathode compartment, in particular, by means of a diaphragm or a membrane, by application of direct current to the electrodes, to put the diluted water/electrolyte solution in a metastable state suitable for disinfection, in which it contains a high proportion of hypochlorous acid.

If only the electrochemically activated, anodic water/electrolyte solution is to be used to produce the inventive disinfectant, only the solution treated in the anode compartment of the reactor, termed the “anolyte,” that is, the solution exiting the anode compartment of the electrolysis reactor is used, while the cathodic solution treated in the cathode compartment, also termed the “catholyte,” can be discarded.

The inventive disinfectant can advantageously exhibit, depending on the application, a sum parameter of free chlorine between approximately 10 mg/l and approximately 70 mg/l, in particular, between approximately 20 mg/l and approximately 60 mg/l, preferably between approximately 30 mg/l and approximately 50 mg/l. Such a value is preferably already adjusted during production, e.g. by electrochemical activation, of the aqueous, hypochlorous acid-containing solution itself, lower or higher values being possible, of course, depending on the desired final product. The adjustment of higher values can, for example, be convenient if the disinfectant is to contain further substances, so that the sum parameter of free chlorine in the solution is adjusted in such a way that the final product has such a value after dilution effects have been taken into account.

The inventive disinfectant can, depending on use, preferably have a pH value of between approximately 2.5 and approximately 8, in particular, up to approximately 7, and a redox potential between approximately 1100 mV and approximately 1360 mV, in particular, between approximately 1150 mV and approximately 1360 mV, preferably between approximately 1200 mV and approximately 1360 mV, wherein, for the aqueous, hypochlorous acid-containing solution, e.g. in the form of a electrochemically activated, anodic, diluted water/electrolyte solution, as such, in particular, a pH value in the range 2.5 to 3.5, preferably 2.8 to 3.2 and, in particular, in the range from 3, and a redox potential in the range 1240 mV and approximately 1360 mV, preferably, between approximately 1280 mV and approximately 1360 mV, in particular, between approximately 1320 mV and approximately 1360 mV, e.g. from approximately 1340 mV, has proven advantageous to ensure the highest possible hypochlorous acid content of the solution with only a low Cl₂ content that is easily released from the solution as gas and can cause an undesirable pungent odor.

For the production of the disinfectant, for this reason, according to an especially preferred embodiment, the pH value of the aqueous, hypochlorous acid-containing solution, e.g. in the form of a electrochemically activated, anodic water/electrolyte solution, is adjusted during electrochemical activation to a value between 2.5 and 3.5, in particular, between 2.7 and 3.3, preferably between 2.8 and 3.2, wherein the redox potential of the electrochemically activated, anodic water/electrolyte solution is preferably adjusted to a value between 1240 mV and 1360 mV, in particular, between 1280 mV and 1360 mV, preferably between 1320 mV and 1360 mV.

The electrochemical activation process to obtain such a disinfectant can therefore be controlled in such way that the solution exiting the anode compartment of the electrolysis reactor, which is physically separated from the cathode compartment by an electrically conductive diaphragm/membrane, or the electrochemically activated, anodic, diluted water/electrolyte solution (anolyte), has a pH value and/or a redox potential in the said range, i.e. the control of the pH value and/or the redox potential is performed in such a way that their stated values have been achieved at the end of the reactor in the anode compartment thereof. In such cases, the redox potential always refers to the normal (NHE) or standard hydrogen electrode (SHE), i.e. vs. NHE or vs. SHE. Various possibilities for control of the electrochemical activation, resulting in such a disinfectant, are described in detail in the international patent application PCT/EP2007/001265 cited above. The electrochemically activated, anodic, diluted water/electrolyte solution with the stated pH and/or redox potential values preferably used for the inventive disinfectant has proven extremely advantageous in that it not only has a practically consistent disinfectant action, in particular, also if used diluted in water, but also ensures a sufficient depot effect, which continues even in the case of heavy microbe contamination. Moreover, as already indicated, the production of chlorine gas according to the above reaction equation (3) can be minimized so that the electrochemically activated, anodic, diluted water/electrolyte solution preferably used for the inventive disinfectant only has a very weak, usually no chlorine odor. The solution contains mainly hypochlorous acid (HOCl) and, in some cases, additional small quantities of hypochlorites, such as sodium hypochlorite (NaClO) and metastable radical compounds and, also in small quantities, hydrogen chloride instead of chlorine gas (Cl₂), i.e. the equilibrium of the above reaction equation (4) is evidently shifted toward the right in the stated pH and/or redox potential value range.

If the pH value of the inventive disinfectant, i.e. at least that of the aqueous, hypochlorous acid-containing solution with the added amorphous silica, is to be increased over this value, for example, to raise it to a skin-friendly pH value in the range of approximately 4 to approximately 8, preferably in the range of up to approximately 7, in particular, up to approximately 6, for example, up to approximately 5.5 or up to approximately 5 and thus to make the disinfectant available for medically effective treatment, for example, for the disinfection of wounds, the pH value of the inventive disinfectant can increased, according to requirements, by the addition of a buffer, in particular, to a value of up to approximately 8, preferably to a value of up to approximately 7 or up to the values stated above. Herein, the said equilibrium between the hypochlorous acid or also its OCl⁻ ions and Cl₂ can be shifted toward the former but, in this case, the inventive addition of the amorphous silica counteracts such a shift so that, in the case of such relatively high pH values, a perfect disinfectant action can be achieved and, moreover, even in the case of a pH value up to approximately 8.0, the redox potential of a disinfectant consisting of the solution with amorphous SiO₂ always remains stable at values clearly above 1100 mV and the free chlorine contained therein is present primarily in the form of hypochlorous acid.

Practically any known buffer can be used as the buffer although, for example, a buffer based on carbonate/hydrogen carbonate has proven successful and presents absolutely no health risks. Moreover, the amorphous silica itself has a certain buffer effect so that, merely by the addition of amorphous SiO₂, a certain increase in the pH value of the water used for the electrochemically activated solution can be achieved in a range of approximately 5 to 5.5, depending on the composition thereof.

Further, it can be an advantage if pure water is used to produce the aqueous, hypochlorous acid-containing solution in the form of an electrochemically activated, diluted water/electrolyte solution to ensure reproducible production conditions and, in particular, to minimize the influence of any ions that may be contained in the raw water. For this purpose, the raw water used for the production of the electrochemically activated, diluted water/electrolyte solution can, in particular, initially undergo a membrane process, such as reverse osmosis, microfiltration, nanofiltration, or ultrafiltration. In this way, in particular, the electric conductivity of the water to be electrochemically activated, or more precisely, its ionic conductivity which is based on the conductivity of the water or the water/electrolyte solution arising from the mobile ions dissolved therein, and their hardness and, if applicable, also the concentration of organic content substances contained therein, can be reduced, wherein a maximum value of the conductivity of approximately 350 μS/cm, preferably between approximately 0.055 μS/cm and approximately 150 μS/cm and, in particular, between approximately 0.055 μS/cm and approximately 100 μS/cm, before the addition of the electrolytic solution (which in itself usually increases the conductivity of the water used by a multiple factor) has proven advantageous. This results in still better reproducibility with respect to the disinfectant action and depot effect during production of the diluted water/electrolyte solution used for the inventive disinfectant, practically irrespective of the water used. Additionally, ions contained in the water to be electrochemically activated that can be transformed during the electrochemical activation into substances posing a health hazard, even if in only small concentrations, are at least largely eliminated. One example are bromide ions that can be oxidized to become bromate, which has a carcinogenic effect in higher concentrations.

The inventive method can also be performed continuously, semicontinuously, in batches, or discontinuously.

As stated above, the inventive disinfectant is suitable, in particular, for the disinfection of surfaces, including human and animal skin, wherein the amorphous silica added to the aqueous, hypochlorous acid-containing solution has a long-term disinfectant action and, if desired, exhibits sufficiently high viscosity to enable its application to the relevant surface in the form of a gel. Especially in the case of application of the disinfectant for the disinfection of human or animal skin, including mucous membranes, and for disinfection of wounds, the following properties provide additional advantages: Because of its high water content, the wound is protected from drying out, and cell division and cell migration are facilitated. It reliably prevents infections, wherein its components are extremely skin-compatible and present no health risks so that it can be used, for example, in the oral and pharyngeal region. This applies, in particular, also to the amorphous silica, which unlike most crystalline silica modifications, is largely inert and does not exhibit any ion exchange properties that are potentially harmful to the organism. It contains no iodine, is colorless and is able to absorb excess wound exudate. It can be rinsed with water without any problem and can be disposed harmlessly in domestic waste or drains.

Moreover, the inventive disinfectant is, of course, also suitable for disinfection of liquid media of any type, such as, in particular, also water, with which it can be mixed practically without limit, wherein it can be dosed in the required quantity in the medium in question without any problem. In this case, the amorphous silica can, because of its adsorptive properties, additionally act in the manner of a precipitation agent, to which suspended substances in the medium to be disinfected can attach themselves.

Further features and advantages of the invention result from the following description of an embodiment of a method for the production of an inventive disinfectant with reference to the drawing. The illustrations show:

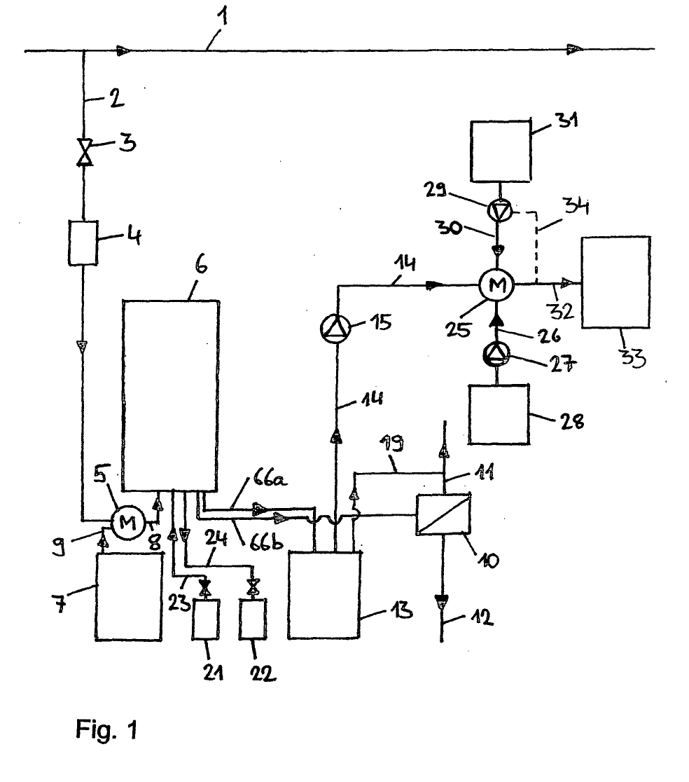

FIG. 1 a schematic flow diagram of an embodiment of an inventive method for the production of a disinfectant based on an aqueous, hypochlorous acid-containing solution in the form of a electrochemically activated, diluted water/electrolyte solution with amorphous silica dispersed into it;

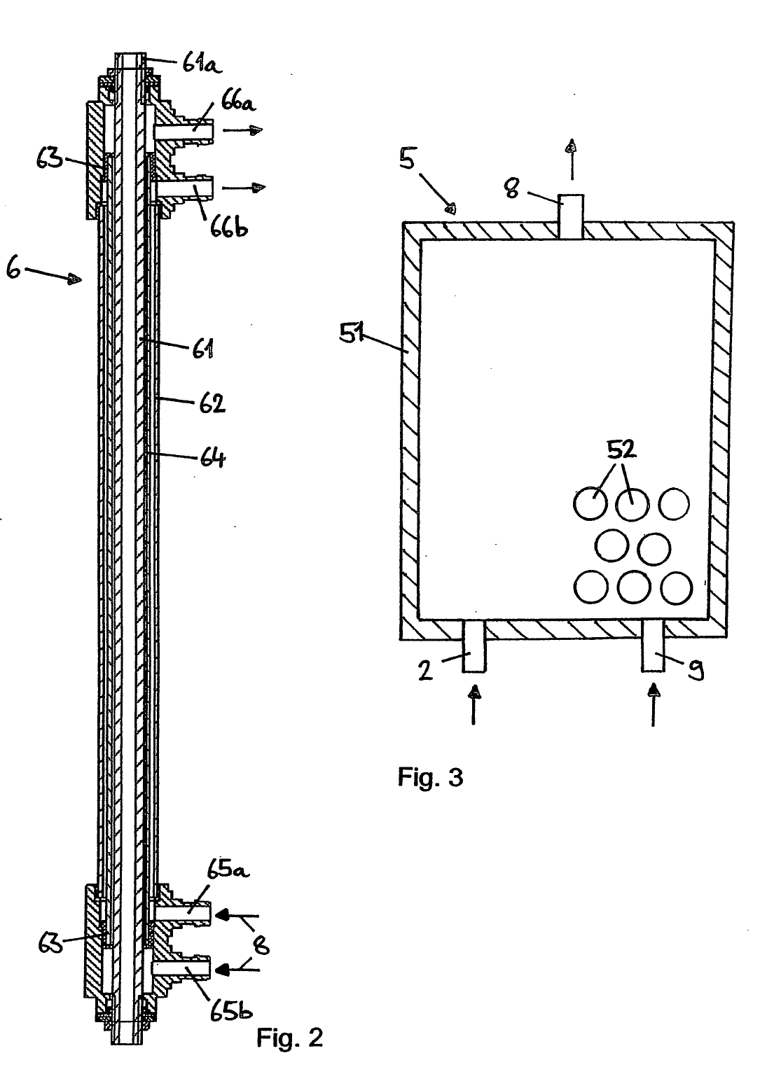

FIG. 2a sectional detail view of the electrolysis reactor according to FIG. 1; and

FIG. 3a sectional detail view of the mixer according to FIG. 1.

The plant represented schematically in FIG. 1 that is suitable for performing the inventive method continuously or semicontinuously for the production of a disinfectant diverts water from a main water pipe 1 via a branch pipe 2 that is used as raw water for the electrochemical activation (ECA). The main water pipe 1 may, for example, be part of a public water supply system. The branch pipe 2 is equipped with a valve 3, in particular, in the form of a control valve, and with a filter 4, in particular, in the form of a fine filter with a hole width of, for example, approximately 80 to 100 μm, and via a mixer 5, which is explained further below with reference to FIG. 3, which opens into an electrolysis reactor 6, which is also described further below with reference to FIG. 2. A partial flow, which can be controlled as required using the control valve 3, of the water being conveyed in the main water pipe 1 can therefore be transferred into the electrolysis reactor 6 via the branch pipe 2.

The mixer 5 is connected on the inlet side to the branch pipe 2 and on the other side to a reservoir 7 to accept an electrolyte solution, for example, in this case, a largely saturated sodium and/or potassium chloride solution, which are mixed together as homogeneously as possible in the mixer 5 and enter the electrolysis 6 via a common pipe 8 on the outlet side. The pipe 9 leading into the mixer 5 from the reservoir 7 is also equipped with a dosing pump, not depicted in FIG. 1, to add a defined quantity of electrolyte solution to the water conveyed in the branch pipe 2. As can be seen, in particular, in FIG. 3, the mixer 5 is constituted by a ball mixer in this embodiment, which ensures constantly consistent mixture of the water with the electrolyte solution. It essentially comprises an approximately cylindrical vessel 51, to whose opposite ends the inlets 2, 9 and the outlet 8 respectively are connected and in which a loose load of balls 52 indicated by way of example in FIG. 3 or another loose material is disposed, through which the water and the electrolyte solution flow, wherein the balls 52 are stimulated to vibrate and thereby ensure very homogeneous mixture of the water with the electrolytic solution added thereto.

As can be seen, in particular, in FIG. 2, the electrolysis reactor 6 comprises an anode 61, that is constituted, in this embodiment, for example, by a hollow tube made of titanium with a coating of ruthenium dioxide (RuO₂), which has an additional catalytic effect, and to the end of which the plus pole of a voltage source, not shown in any further detail, can be connected by means of an external thread 61a. As an alternative or in addition to ruthenium oxide, a coating, for example, based on iridium dioxide (IrO₂), or a mixture of both (RuO₂/IrO₂), or other oxides, such as titanium dioxide (TiO₂), lead dioxide (PbO₂) and/or manganese dioxide (MnO₂) can be also provided. The electrolysis reactor 6 further comprises a cathode 62, which is advantageously made of high-grade steel or a similar material, such as nickel (Ni), platinum (Pt), etc., and, in this embodiment, is also constituted by a hollow tube within which the anode 61 is coaxially disposed. The cathode 62 can be connected, for example, by means of clamps fitting round the outside (not depicted) to the minus pole of the voltage source, which is not described in further detail. Coaxially with the anode 61 and the cathode 62 and between these, a tubular diaphragm 64 sealed by means of sealing rings 63 is disposed that separates the ring-shaped reaction compartment located between the anode 61 and the cathode 62 into an anode compartment and into a cathode compartment. The diaphragm 64 prevents mixture of the liquid located in the anode compartment and cathode compartment, but nevertheless permits a flow of current that does not provide any great resistance, in particular, for the migration of ions. The diaphragm 64 in this embodiment, for example, is constituted by electrically, that is, ionically, conductive, but essentially liquid-tight, porous zirconium dioxide (ZrO₂). Other materials with relatively low resistance, such as aluminum oxide (Al₂O₃), ion exchange membranes, in particular, those based on plastics, etc., can also be deployed.

Furthermore, the electrolysis reactor 6 has two inlets 65a, 65b, via which the diluted water/electrolyte solution exiting the mixer 5 via the pipe 8 is fed into the reaction compartment of the reactor 6, that is, into its anode compartment and into its cathode compartment physically separated from the former by the diaphragm 64. An, e.g. approximately T-shaped, branch for this purpose is not shown in FIG. 1. As can be seen, in particular, from FIG. 3 and also from FIG. 1, the electrolysis reactor 6 also has two outlets 66a, 66b, via which the water/electrolyte solution can be drained from the reactor 6 after chemical activation therein. Whereas the outlet 66a is for removal of the electrochemically activated water/electrolyte solution from the anode compartment of the reactor 6, i.e. for removal of the “anolyte,” the outlet 66b is for removal from the cathode compartment, that is, for removal of the “catholyte.” Moreover, it is possible for the “anolyte,” i.e. the electrochemically activated, anodic water/electrolyte solution, also to be discarded during start-up of the electrolysis reactor 6 over a certain period to exclude initial quality impairment until the electrolysis reactor 6 has reached its desired operating state.

The geometric dimensions of the electrolysis reactor 6 used in this case is given in the form of a list below:

Length of the cathode compartment: 18.5 cm;
Volume of the cathode compartment: 10 ml;
Surface of the cathode: 92.4 cm²;
Length of the anode compartment: 21.0 cm;
Volume of the anode compartment: 7 ml;
Surface of the anode: 52.7 cm²;
Distance between cathode and anode: approx. 3 mm (including diaphragm).

The electrolysis reactor 6 is operated with a water throughput of, for example, 60 to 140 I/h although greater throughputs are possible, of course, by using larger reactors and/or multiple reactors connected in parallel. The electrolysis reactor 6 is preferably always run at full load, wherein it can be shut down as required and peak loads can be handled using a storage tank explained in more detail further below for the electrochemically activated, anodic, diluted water/electrolyte solution.

As can be seen from FIG. 1, the outlet 66b opens from cathode compartment of the electrolysis reactor 6 into a gas separator 10, from which the waste gas is removed via an optionally provided waste gas pipe 11, while the catholyte itself, i.e. the water/electrolyte solution removed from the cathode compartment of the electrolysis reactor 6 is removed via a pipe 12, e.g. into the drains of a public sewage system. The output 66a from the anode compartment of the electrolysis reactor 6 opens into a storage tank 13, in which a stock of the electrochemically activated, diluted water/electrolyte solution used for the disinfectant can be kept and from which the anolyte can be removed via a pipe 14, which can be achieved using a dosing pump 15 disposed in the pipe 14.

The electrolysis reactor 6 is equipped with the controllable voltage source, not depicted in any greater detail in FIG. 1, to control the desired current flow between the anode 61 and the cathode 62 (FIG. 2), which is, for example, measured using an ammeter (not depicted). It also has a pH meter disposed, for example, in the outlet 66a for the anolyte (also not depicted), which can alternatively be provided, for example, in the storage tank 13. A controllable pump that can be integrated, for example, into the reactor 6 (also not depicted) is used to convey the diluted water/electrolyte solution through the electrolysis reactor in a controllable manner, wherein the pump controls the volume flow rate and therefore the residence time of the water/electrolyte solution in the reactor 6. A control device, also not depicted in any further detail, for example, in the form of an electronic data processing unit is provided for control of the said parameters in such a way as to maintain a pH value of between 2.5 and 3.5, preferably in the range of approximately 3.0 in the anolyte exiting the anode compartment of the reactor 2 via the outlet 66a, which can be achieved, for example, by means of PID controllers. For the details of the control technology for open-loop and closed-loop control of the pH value of the electrochemically activated, anodic, diluted water/electrolyte solution (anolyte), we refer to the international patent application PCT/EP2007/001265 cited further above. The same applies to an advantageous open-loop or closed-loop control of the redox potential of the electrochemically activated, anodic, diluted water/electrolyte solution in the range 1340 mV.

To permit cleaning of the electrolysis reactor 6, a storage vessel 21 to take up the cleaning liquid, e.g. acetic acid or similar, and, optionally, a storage vessel 22 to take up spent cleaning liquid can also be provided, wherein a feed line 23 leading from the storage vessel 21 into the reactor 6 with the inlets 65a, 65b of the reactor 6 (cf. FIG. 2) and a pipe 24 leading from the reactor 6 into the storage vessel 22 with the outlets 66a, 66b of the reactor 6 (cf. FIG. 2) can be connected as required to rinse the reactor 6, i.e. both its cathode compartment and also, in particular, its anode compartment. As an alternative, the cleaning solution, in particular, in the case of an environmentally compatible and biologically degradable cleaning liquid, such as acetic acid, can be fed directly, for example, into a public sewage system.

To increase the life of the electrolysis reactor 6 or to extend its service intervals, a softener, not depicted in FIG. 1, can be connected upstream thereof to keep the hardness of the water, for example, at a value of no more than 4° dH (corresponding to a concentration of alkaline-earth metal ions of 0.716 mMol/l), preferably of no more than 2° dH (corresponding to a concentration of alkaline-earth metal ions of 0.358 mMol/l). The softener can be of a conventional design and, for example, equipped with a suitable ion exchanger resin to replace the divalent water hardness minerals that may be in the water, that is, calcium and magnesium ions, with monovalent ions, such as sodium. As an alternative or additionally, in particular, a device connected, for example, downstream of the softener to reduce the electrical, that is, ionic conductivity, of the water (also not depicted) can be provided that can be constituted, in particular, by a membrane system, such as a reverse osmosis system or a microfiltration, nanofiltration, or ultrafiltration system and that keeps the electrical conductivity of the water at a value, of, for example, no more than approximately 350 μS/cm, in particular, no more than approximately 150 μS/cm, preferably no more than approximately 100 μS/cm. A conductivity measurement set-up, also not depicted, such as a conductivity measurement cell, electrode, or similar can be used to monitor adherence to the desired value for the electrical conductivity of the raw water.

As can also be seen from FIG. 1, the pipe 14 from the storage tank 13 for the electrochemically activated, anodic, diluted water/electrolyte solution opens into a further mixer 25, which can be constituted like mixer 5 (see also FIG. 3) or in any other way. The mixer 25 is used for dispersing amorphous silica as homogeneously as possible into the electrochemically activated solution being conveyed in pipe 14 and is connected for this purpose via a pipe 26 that is equipped with a controllable dosing pump 27 with a storage vessel 28 for the amorphous silica. The silica used can be, for example, finely particular pyrogenic silicic acid of the type “HDK® T30” (Wacker Chemie A G, Munich, Germany), i.e. a synthetic, hydrophilic, amorphous, flame-hydrolytically produced silicic acid with a SiO₂ content greater than 99.8%, a density of the SiO₂ of 2200 g/l and a silanol group density of 2 SiOH/nm². It can be added to the electrochemically activated solution in solid or pre-dispersed form, e.g. in water. Depending on the desired viscosity of the final product, it can be added to the electrochemically activated solution, for example, in a mass ratio of approximately 1:10, which is achieved using the dosing pump 27.

The mixer 25 is also connected via a pipe 30, also equipped with a controllable dosing pump 29, with a further storage tank 31, which is used to stock a buffer, for example, sodium carbonate/sodium hydrogen carbonate or an aqueous solution thereof. In this way, the pH value of the electrochemically activated, anodic, diluted water/electrolyte solution conveyed in the pipe 14 can be raised to a higher pH value than approximately 3 (e.g. approximately 4 to 7), if this is desired, for example, to achieve good skin compatibility of the final disinfectant. For this purpose, the dosing pump 29 is connected, for example, to a pH meter (not depicted) disposed in the pipe 32, which carries the already homogenized product from the mixer 25 into a storage vessel 33, from which it can be taken, portioned, and packaged, as is indicated with the dashed line 34. In this way, the corresponding quantity of the corresponding buffer solution can be automatically apportioned based on the desired pH value of the final disinfectant.

It is evident that, instead of this continuous process, discontinuous process control is also possible according to which the electrochemically activated, anodic, diluted water/electrolyte solution is conveyed from the pipe 14, for example, into one or more agitator tanks (not shown), where the corresponding quantity of amorphous SiO₂ and, if applicable, buffer is added to it. Moreover, the electrochemically activated, anodic, diluted water/electrolyte solution can be used in undiluted form or, if applicable, also in a form diluted, in particular, with water or pure water. A content of electrochemical activation products with a disinfectant action suitable for ideal disinfection is equivalent, for example, to approximately 40 mg/l of the sum parameter of free chlorine. Of course, higher or lower concentrations can also be adjusted, for example, by suitably increasing/decreasing the electrode current, the apportioned quantity of common salt solution added, the residence time of the diluted water/electrolyte solution in the electrolysis reactor 6, etc. Finally, the continuous phase of the inventive disinfectant based on the aqueous, hypochlorous acid-containing solution need not necessarily be produced using electrochemical activation, but any other known production methods can be considered.

1-16. (canceled)

17. A method of disinfecting an object, the method comprising the step of:
subjecting the object to a disinfecting aqueous, hypochlorous acid (HOCl)-containing solution having a pH-value between 2.5 and 8 which also contains a proportion of amorphous silica (SiO₂).

18. The method of claim 1, wherein the amorphous silica is present in a form of amorphous silicic acids and/or amorphous silicic anhydrides.

19. The method of claim 17, wherein the disinfecting solution contains a sufficient proportion of amorphous silica to increase a viscosity of the aqueous, hypochlorous acid-containing solution.

20. The method of claim 17, wherein the disinfecting solution exhibits a gel-like consistency.

21. The method of claim 17, wherein a mass ratio of the aqueous, hypochlorous acid-containing solution to the amorphous silica is between 100:1 and 1:1 or between 50:1 and 2:1.

22. The method of claim 17, wherein the aqueous, hypochlorous acid-containing solution is constituted by an electrochemically activated, diluted water/electrolyte solution.

23. The method of claim 22, wherein the aqueous, hypochlorous acid-containing solution is constituted exclusively by an electrochemically activated, anodic, diluted water/electrolyte solution.

24. The method of claim 17, wherein the disinfecting solution exhibits a pH value between 2.5 and 7, in dependence on use.

25. The method of claim 17, wherein the disinfecting solution exhibits a redox potential between 1100 mV and 1360 mV, between 1150 mV and 1360 mV or between 1200 mV and 1360 mV.

26. The method of claim 17, wherein the disinfecting solution exhibits a sum parameter of free chlorine between 10 mg/l and 70 mg/l, between 20 mg/l and 60 mg/l or between 30 mg/l and 50 mg/l.

27. The method of claim 17, wherein the disinfecting solution contains a buffer which increases the pH value thereof.

28. The method of claim 27, wherein the buffer is based on carbonate/hydrogen carbonate.

29. The method of claim 17, wherein the aqueous, hypochlorous acid-containing solution is made from pure water.

30. The method of claim 17, wherein a surface of the object is disinfected.

31. The method of claim 17, wherein the disinfecting solution is a pharmaceutical disinfectant for human and animal skin.

32. The method of claim 17, wherein the object is a liquid medium or water.
